(19) United States
(12) Patent Application Publication
(10) Pub. No.: US 2006/0158408 A1
(43) Pub. Date: Jul. 20, 2006

(54) Liquid crystal display device

(75) Inventor: Takuya Hirose, Saitama (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba Matsushita Display Technology Co., Ltd., Minato-ku (JP)

(21) Appl. No.: 11/305,232

(22) Filed: Dec. 19, 2005

(30) Foreign Application Priority Data
Jan. 18, 2005 (JP) 2005-010979

(51) Int. Cl. G09G 3/36

(52) U.S. Cl. 345/87

(57) ABSTRACT

A left TFT 26 and a right TFT 28 are provided at both sides of one signal line 24, a first scanning line 30 to supply a gate signal to the left TFT 26 is provided, a second scanning line 32 to supply a gate signal to the right TFT 28 is provided, an image output circuit 42 to supply image signals for four pixels to two signal lines 24 is provided, a first switching element 44 and a second switching element 46 to switch the image signals supplied to the two signal lines 24 are provided, and the first switching element 44 and the second switching element 46 are switched by control signals from a first control line 38 and a second control line 40.

### CROSS-REFERENCE TO RELATED APPLICATIONS

This application is based upon and claims the benefit of priority from the prior Japanese Patent Application No. 2005-10979, filed on Jan. 18, 2005; the entire contents of which are incorporated herein by reference.

### TECHNICAL FIELD

The present invention relates to a liquid crystal display device.

### BACKGROUND OF THE INVENTION

Hitherto, in a liquid crystal display device, in order to send an image signal of one output from an image output circuit in a signal line driving circuit to each of four signal lines, a switch part is provided in an outer peripheral part on an array substrate, and the image signal is sent from the image output circuit to the signal lines by switching of the switch part (see, for example, JP-A-2003-114656). For the purpose of controlling the switch part to switch the signal lines as stated above, four control lines are provided in the outer peripheral part of the array substrate.

However, when a reduction in width of a frame around an array substrate is advanced, there is a problem that it becomes difficult to arrange the switch part and the four control lines in the outer peripheral part of the array substrate.

Then, in view of the problem, the invention provides a liquid crystal display device in which the number of switching elements to switch signal lines and the number of control lines are decreased, and the area occupied by the switching elements and the control lines on an array substrate can be decreased.

### BRIEF SUMMARY OF THE INVENTION

According to embodiments of the present invention, a liquid crystal display device includes (m×2) signal lines arranged in parallel to one another, a switching element group in which n pairs each including a first and a second switching elements arranged to face each other across each of the signal lines and connected to the signal line are arranged along the signal line, a pixel electrode connected to each of the switching elements of the switching element group, n first scanning lines which are arranged to be orthogonal to the signal lines and each of which is connected to the respective (m×2) first switching elements arranged to form a line in a direction orthogonal to the signal line, n second scanning lines which are arranged to be orthogonal to the signal line and each of which is connected to the respective (m×2) second switching elements arranged to form a line in the direction orthogonal to the signal line, a signal line driving circuit to supply image signals for four pixels to each of half of the signal lines in one horizontal period, a third switching element and a fourth switching element which are connected to each of pairs of the signal lines, each of the pairs including two adjacent signal lines in the signal lines, to perform switching so that an image signal is supplied from the signal line driving circuit to one of the signal lines of the pair, a control circuit to control on/off of the third and the fourth switching elements through a first control line and a second control line respectively connected to the third switching element and the fourth switching element, and a scanning line driving circuit which supplies a gate signal to the first scanning line to bring the first switching element into an on state and to write the image signal supplied from the signal line driving circuit through the third switching element or the fourth switching element into the pixel electrode connected to the first switching element, and supplies a gate signal to the second scanning line to bring the second switching element into an on state and to write the image signal supplied from the signal line driving circuit through the third switching element or the fourth switching element into the pixel electrode connected to the second switching element.

According to the liquid crystal display device of an embodiment of the invention, the number of the switching elements to switch the signal lines can be made half of the signal lines, and the control lines to control the switching elements can also be halved.

### BRIEF DESCRIPTION OF THE DRAWINGS

FIG. 1 is an explanatory view of a liquid crystal display device showing an embodiment of the invention.

FIG. 2 is a circuit diagram showing an equivalent circuit of the liquid crystal display device

FIG. 3 is a timing chart of drive waveforms in the liquid crystal display device.

### DETAILED DESCRIPTION OF THE INVENTION

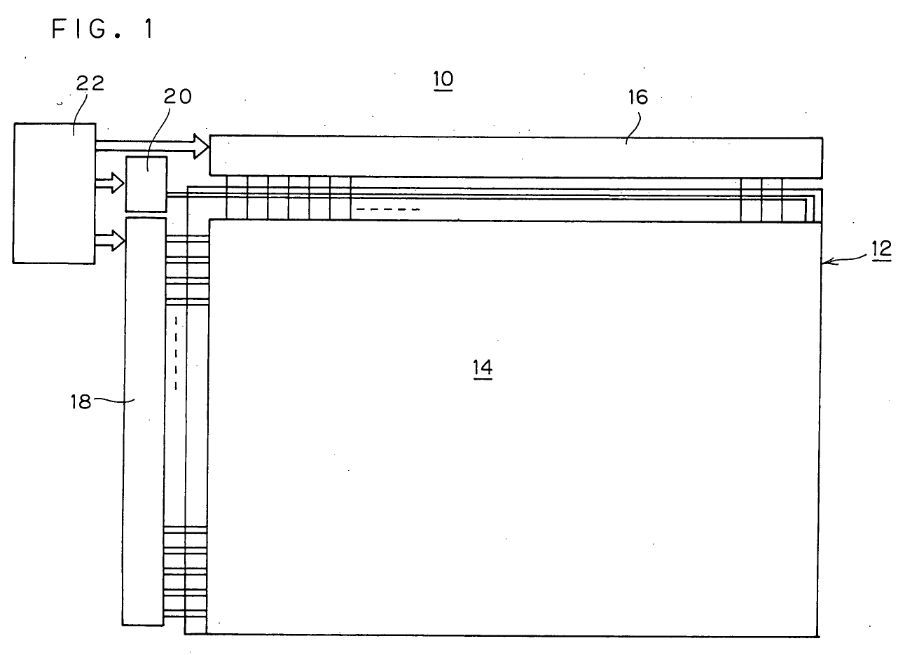

A liquid crystal display device 10 of an embodiment of the invention will be described with reference to FIGS. 1 to 3.

A liquid crystal panel 12 of the liquid crystal display device 10 includes an array substrate 14, a not-shown counter substrate, and a liquid crystal layer sandwiched between these substrates through an oriented film and made of a twisted nematic liquid crystal.

As shown in FIG. 1, the liquid crystal panel 12 includes a signal line driving circuit 16, a gate line driving circuit 18, a switching control circuit 20, and a main control circuit 22 to control the signal line driving circuit 16, the gate line driving circuit 18 and the switching control circuit 20.

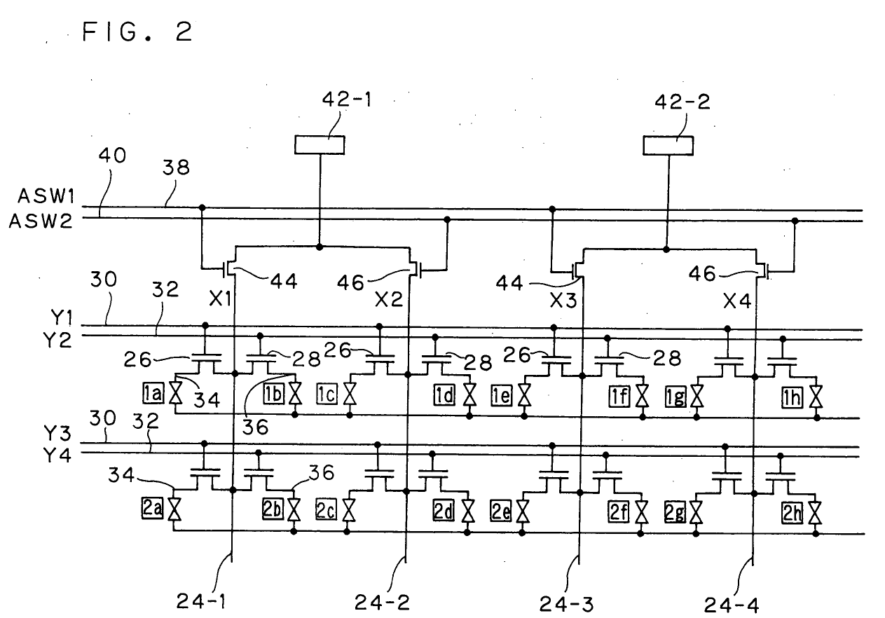

Next, the structure of the array substrate 14 will be described with reference to FIG. 2.

On the array substrate 14, (m×2) (for example, m×2=1028×3÷2; 1028 for each of RGB) signal lines 24-1, 24-2, . . . , 24-m, . . . , 24-(m×2) (hereinafter also generically referred to as signal lines 24) are provided in parallel to one another in the drawing in the up-and-down direction. A pair of right and left thin film transistors (TFT) are arranged to face each other across each of the signal lines 24 in the drawing, and pixel electrodes are connected thereto. Hereinafter, the TFT provided at the left side of the signal line 24 is referred to as a left TFT 26, and the TFT provided at the right side thereof is referred to as a right TFT 28.

Then, n pairs (for example, 724 pairs) each including the pair of right and left TFTs 26 and 28 are provided in the up-and-down direction with respect to one signal line 24. Incidentally, the right-and-left direction and the up-and-down direction in the present specification indicate the directions in FIG. 2.

N first scanning lines 30 are provided in the right-and-left direction orthogonal to the respective signal lines 24-1, 24-2, . . . , 24-m, . . . , 24-(m×2), and second scanning lines 32 are provided in parallel to the first scanning lines 30 and in the right-and-left direction. The first scanning line 30 and the second canning line 32 are provided between the left TFT 26 and the left TFT 26 at its lower stage, and on the whole array substrate 14, the n first scanning lines 30 are provided, and the n second scanning line 32 are also provided.

A gate electrode of the left TFT 26 is connected to the first scanning line 30, its source electrode is connected to the signal line 24, and its drain electrode is connected to a left pixel electrode 34. The n first scanning lines 30 and the n second scanning lines 32 are connected to the gate line driving circuit 18.

A gate electrode of the right TFT 28 is connected to the second scanning line 32, its source electrode is connected to the signal line 24, and its drain electrode is connected to a right pixel electrode 36.

M image signal output circuits 42-1, . . . 42-m included in the signal line driving circuit 16 are provided on a TCP (Tape Carrier Package) attached to an outer part of the array substrate 14. Each of the image output circuits 42 outputs image signals for four pixels in one horizontal period.

M pairs each including a first switching element 44 and a second switching element 46 made of a TFT are provided in an upper part outside an image display area of the array substrate 12. In two adjacent signal lines, for example, in the signal lines 24-1 and 24-2, a source electrode of the first switching element 44 is connected to an upper end of the left one signal line 24-1, and a source electrode of the second switching element 46 is connected to an upper end of the right one signal line 24-2. The m first switching elements 44 and the m second switching elements 46 are respectively provided. A first control line 38 and a second control line 40 are provided in the upper part outside the image display area of the array substrate 14 and in the right-and-left direction. The first control line 38 and the second control line 40 are connected to the switching control circuit 20. The first control line 38 is connected to a gate electrode of the first switching element 44, and the image signal output circuit 42-1 is connected to its drain electrode. The second control line 40 is connected to a gate electrode of the second switching element 46, and the same image signal output circuit 42-1 is connected to its drain electrode. Similarly, the two signal lines of the signal lines 24-3, 24-4, . . . , 24-(m×2−1), 24-(m×2) are connected to each of the other image signal output circuits 42-2, . . . 42-m.

The first switching element 44 outputs an image signal sent from the image output circuit 42 to the signal line 24 based on a first control signal outputted from the first control line 38. The second switching element 46 outputs an image signal outputted from the image output circuit 42 based on a second control signal outputted from the second control line 40. This timing will be described later in detail.

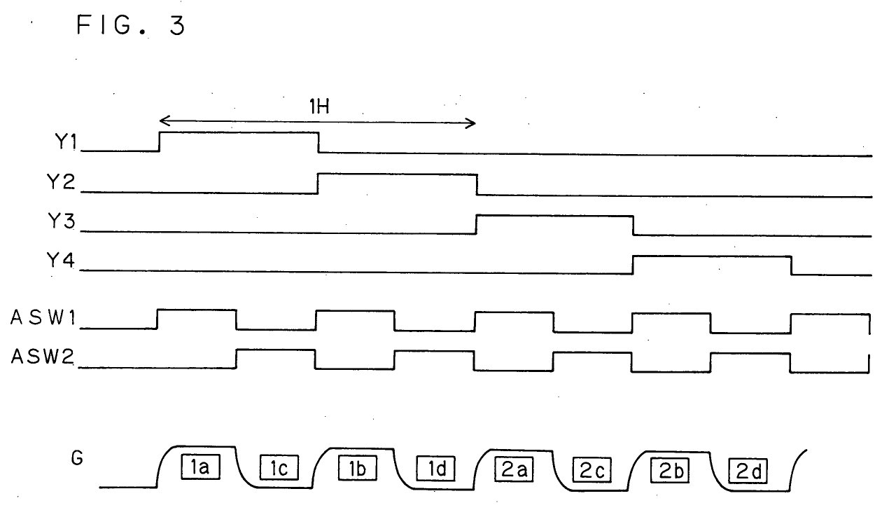

Next, a driving state of the liquid crystal display device 10 will be described with reference to FIG. 2 and FIG. 3.

As shown in FIG. 3, image signals G for four pixels are outputted from one image output circuit 42 (the image output circuit 42-1 is shown as an example in FIG. 3) in one horizontal period (1H).

A gate signal Y1 having a time width of a ½ horizontal period (H/2) is outputted from the first scanning line 30 at a first stage in one horizontal period. Besides, a gate signal Y2 which has the ½ horizontal period and is shifted from the gate signal Y1 of the first scanning line 30 by the ½ horizontal period is outputted from the second scanning line 32 in one horizontal period. Subsequently, gate signals shifted from each other by the ½ horizontal period are outputted from the first scanning line 30 and the second scanning line 32 at each stage.

The first control line 38 outputs a first control signal ASW1 every ¼ horizontal period (H/4), the second control line 40 outputs a second control signal ASW2 every ¼ horizontal period (H/4), and the second control signal ASW2 is shifted from the first control signal ASW1 by the ¼ horizontal period.

The signals as stated above are outputted, so that image signals are written into the respective pixel electrodes as stated below.

Attention is paid to two adjacent signal lines, for example, the signal lines 24-1 and 24-2, and an image signal G-1a for one pixel is written into the left pixel electrode 34 of the left TFT 26 of the one signal line 24-1 in the ¼ horizontal period.

In the next ¼ horizontal period, an image signal G-1b for one pixel is written into the pixel electrode 34 of the left TFT 26 of the other signal line 24-2.

In the next ¼ horizontal period, an image signal G-1c for one pixel is written into the right pixel electrode 36 connected to the right TFT 28 of the one signal line 24-1.

In the final ¼ horizontal period, an image signal G-1d for one pixel is written into the right pixel electrode 36 of the right TFT 28 of the other signal line 24-2.

The above operation is performed in every two signal lines 24 in one horizontal period, and in the whole screen, the image signals G are written into all the pixel electrodes in one horizontal line in the one horizontal period.

Then, the writing shifts to the horizontal line at the next stage, and finally, an image of one frame is displayed.

As stated above, in one horizontal period, image signals for four pixels can be written every ¼ horizontal period.

In the outer peripheral part of the array substrate 12, since the two control lines 38 and 40 and the m switching elements 44 and 46 are merely provided, the wiring area can be made small, and the width of the frame can be narrowed.

When attention is paid to the signal line 24, one signal line is connected to the pair of right and left TFTs 26 and 28, and unlike the related art, one signal line is not connected to one TFT, and therefore, the number of the signal liens 24 can be made smaller than the number of the conventional signal lines.

Since the image output circuit 42 is also put in such a state that the image signals are sent to the two TFTs 26 and 28, the number of the image output circuits 42 can also be reduced to half as compared with the related art.

What is claimed is:

1. A liquid crystal display device comprising:
(m×2) signal lines arranged in parallel to one another;
a switching element group in which n pairs each including a first and a second switching elements arranged to face each other across each of the signal lines and connected to the signal line are arranged along the signal line;
a pixel electrode connected to each of the switching elements of the switching element group;
n first scanning lines which are arranged to be orthogonal to the signal lines and each of which is connected to the respective (m×2) first switching elements arranged to form a line in a direction orthogonal to the signal lines;
n second scanning lines which are arranged to be orthogonal to the signal lines and each of which is connected to the respective (m×2) second switching elements arranged to form a line in the direction orthogonal to the signal lines;
a signal line driving circuit to supply image signals for four pixels to each of half of the signal lines in one horizontal period;
a third switching element and a fourth switching element which are connected to each of pairs of the signal lines, each of the pairs including two adjacent signal lines in the signal lines, to perform switching so that an image signal is supplied from the signal line driving circuit to one of the signal lines of the pair;
a control circuit to control on/off of the third and the fourth switching elements through a first control line and a second control line respectively connected to the third switching element and the fourth switching element; and
a scanning line driving circuit which supplies a gate signal to the first scanning line to bring the first switching element into an on state and to write the image signal supplied from the signal line driving circuit through the third switching element or the fourth switching element into the pixel electrode connected to the first switching element, and supplies a gate signal to the second scanning line to bring the second switching element into an on state and to write the image signal supplied from the signal line driving circuit through the third switching element or the fourth switching element into the pixel electrode connected to the second switching element.

2. The liquid crystal display device according to claim 1, wherein
the control circuit supplies a first control signal to the first control line to bring the third switching element into an on state every ¼ period of the horizontal period, and supplies a second control signal to the second control line to bring the fourth switching element into an on state at a timing shifted from the on state of the third switching element by a ¼ horizontal period and every ¼ period of the horizontal period, and
the scanning line driving circuit supplies the gate signal to the first scanning line to bring the first switching element into the on state in a ½ horizontal period, and supplies the gate signal to the second scanning line to bring the second switching element into the on state at a timing shifted from the on state of the first switching element by a ½ horizontal period and in a ½ horizontal period.

3. The liquid crystal display device according to claim 2, wherein in a case where the pixel electrodes connected to the first and the second switching elements of the two pairs connected to the adjacent two signal lines are a first, a second, a third and a fourth pixel electrodes,
in a first ¼ horizontal period, an image signal for one pixel is written into the first pixel electrode through the first switching element,
in a next ¼ horizontal period, an image signal for one pixel is written into the third pixel electrode through the first switching element,
in a next ¼ horizontal period, an image signal for one pixel is written into the second pixel electrode through the second switching element, and
in a final ¼ horizontal period, an image signal for one pixel is written into the fourth pixel electrode through the second switching element.
